(19) United States
(12) Patent Application Publication
(10) Pub. No.: US 2018/0054801 A1
(43) Pub. Date: Feb. 22, 2018

(54) BROADCAST DOWNLINK CONTROL INFORMATION DECODABLE BY VARIABLE BANDWIDTH

(71) Applicant: GUSTAV GERALD VOS, SURREY (CA)

(72) Inventor: GUSTAV GERALD VOS, SURREY (CA)

(73) Assignee: SIERRA WIRELESS, INC., RICHMOND (CA)

(21) Appl. No.: 15/680,547

(22) Filed: Aug. 18, 2017

Related U.S. Application Data
(60) Provisional application No. 62/376,775, filed on Aug. 18, 2016.

(51) Int. Cl. H04W 72/00; H04W 72/04

(52) U.S. Cl. CPC H04W 72/005; H04W 72/0453

(57) ABSTRACT

A method and apparatus for communicating a broadcast signal is provided. Plural broadcast signal units are transmitted in plural contiguous or non-contiguous frequency bands. Some or all of the broadcast signal units may be retransmitted, such that each of the broadcast signal units is retransmitted in a same frequency band as previously or in a different frequency band. In embodiments, one or more of the broadcast signal units may be transmitted with increased power and one or more of the broadcast signal units may be omitted or transmitted with reduced power. In embodiments, when a first broadcast signal unit of a first cell and in a first frequency band is transmitted with increased power, broadcast signal units of nearby cells being transmitted in a frequency band overlapping the first frequency band are not transmitted or are transmitted with reduced or unboosted power.

### CROSS REFERENCE TO RELATED APPLICATIONS

This application claims the benefit of priority to U.S. Provisional Patent Application Ser. No. 62/376,775 filed on Aug. 18, 2016 and entitled Broadcast Downlink Control Information Decodable by Variable Bandwidth, the contents of which are incorporated by reference.

### FIELD OF THE INVENTION

The present invention pertains to the field of wireless communications and in particular to methods and apparatus for broadcasting downlink control information to wireless devices.

### BACKGROUND

The 3^{rd} Generation Partnership Project (3GPP) is currently developing standards for 5^{th} generation (5G) wireless communication systems.

In existing 3GPP 4^{th} generation (4G) wireless communication systems, User Equipments (UEs) with bandwidth reception capability smaller than 1.08 MHz and even UEs that support reception of less than 20 MHz bandwidths (e.g. Category M1-1 MHz and Category NB1-180 KHz, wherein such categories have been designated by the 3GPP) could not decode legacy Long Term Evolution (LTE) control. This required re-broadcast within the narrower bandwidth. For Category M1, the issue was not as bad as only large system information blocks (SIBs) would need to be re-broadcasted but for Category NB1—all broadcast information needed to be re-designed and then re-broadcasted. For the Narrowband Internet of Things (NB-IoT), the broadcast information utilizes up to 40% of the available capacity. Unlike unicast data, broadcasted information is sent 24×7 and is sent even when there are no bandwidth limited UEs in the cell.

There is a need for a method and apparatus for communicating downlink control information that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and apparatus for communicating downlink control information in a wireless communication system. In accordance with an aspect of the present invention, there is provided a method for communicating a broadcast signal (e.g. a primary synchronization signal (PSS)) in a wireless communication system, the method including generating a plurality of broadcast signal units based at least in part on the broadcast signal. The method further including transmitting the plurality of broadcast signal units in a plurality of different frequency bands.

In accordance with another aspect of the present invention, there is provided a base station of a wireless communication system configured to communicate a broadcast signal, for example a PSS. The base station is configured to generate a plurality of broadcast signal units based at least in part on the broadcast signal, and transmit the plurality of broadcast signal units in a plurality of different frequency bands.

In accordance with another aspect of the present invention, there is provided a wireless device (UE) of a wireless communication system configured to receive and decode one or a plurality of broadcast signal units transmitted in a plurality of different frequency bands and indicative of a broadcast signal.

### BRIEF DESCRIPTION OF THE FIGURES

FIG. 1 illustrates a bandwidth of a legacy PSS in accordance with the prior art.

FIG. 2 illustrates a method for communicating a broadcast signal in a wireless communication network, in accordance with embodiments of the present invention.

FIG. 3 illustrates multiple broadcast signal units each spanning a different (non-overlapping) relatively narrow frequency band, according to an embodiment of the present invention.

FIG. 4 illustrates time and frequency variation in the provision of broadcast signal units, according to an embodiment of the present invention.

FIG. 5 illustrates controlled boosting of broadcast signal units according to an embodiment of the present invention.

FIG. 6 illustrates a configuration in which power-boosted dynamic broadcast signal units of different cells are restricted to different frequency bands at a given time, according to an embodiment of the present invention.

FIG. 7 illustrates a base station such as a eNB transmitting broadcast signal units to multiple wireless devices, according to an embodiment of the present invention.

FIG. 8 illustrates a UE and a base station of a wireless communication network, in accordance with an embodiment of the present invention.

### DETAILED DESCRIPTION OF THE INVENTION

As used herein, the broadcast signal refers to a signal or channel which is broadcasted by the system that allows the UE to decode system configuration information or to acquire timing, or frequency information.

In some embodiments, the broadcast signal is a Primary Synchronization Signal (PSS). In other embodiments, the broadcast signal is a Secondary Synchronization Signal (SSS), a Physical Broadcast Channel (PBCH) Master Information Block (MIB), a broadcast signal indicative of a System Information Block (SIB), or another type of broadcast signal. The concepts disclosed herein can be used for broadcast transmission of a variety of types of information.

As used herein, primary synchronization signaling, reflected in the PSS, allows a UE to get initial timing and frequency information. In current systems, PSS uses Zadoff-Chu codes which are transmitted across 6 Physical Resource Blocks (PRBs) but thus are only decodable by UEs with at least 6 PRBs bandwidth reception capability. The UE currently decodes the PSS through a correlation operation.

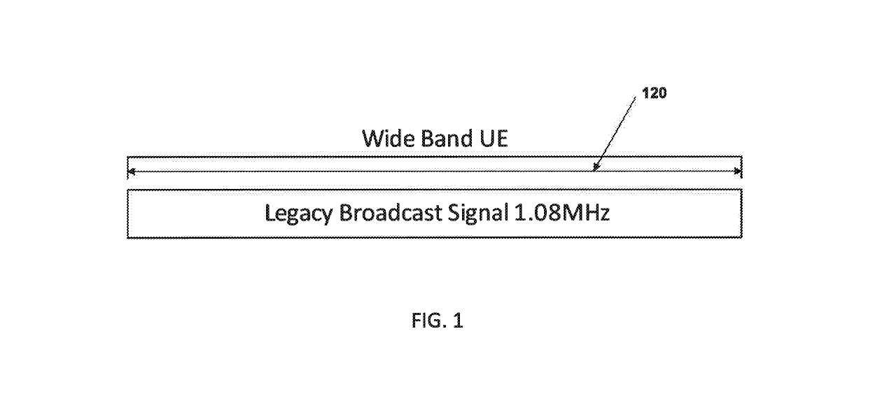

FIG. 1 illustrates a bandwidth 120 of the legacy PSS according to the prior art. This configuration of the legacy PSS has been provided for comparison with embodiments of the present invention.

Embodiments of the present invention provide a method and associated apparatus for communicating a broadcast signal in a wireless communication system. The method includes transmitting a plurality of broadcast signal units in a plurality of different frequency bands.

Embodiments of the present invention can be used in communication systems such as those based on LTE, in order to provide support for narrowband UEs, for example to allow broadcast signals, channels and/or information to be decodable by both narrowband and wideband UEs.

In some embodiments, to avoid duplication, the broadcast signals, channels and/or information are decodable by both wideband and narrowband UEs. In some embodiments, to improve wideband UE performance, broadcast signals, channels and/or information may be configured to use wideband resources not necessarily decodable by narrowband UEs.

In some embodiments, broadcast signals are configured, via the use of broadcast signal units, so that wideband UEs are able to decode the entire wideband broadcast signal while narrowband UEs decode a narrow portion of the same signal, for example a broadcast signal unit. For example, a broadcast signal is converted into a shorter broadcast sequence, such that it can be transmitted across a reduced bandwidth. In some embodiments, the reduced bandwidth is a smallest UE bandwidth (BW) that will be supported by the system. In some embodiments, the smallest UE BW is 180 kHz, however it is readily understood that this is merely an example of a reduced UE BW and other specific reduced UE BWs can be considered for the conversion of a broadcast signal into a broadcast signal unit. The broadcast signal units are generated at least in part based on the broadcast signal.

In some embodiments, a broadcast signal unit is a portion of the legacy broadcast signal, wherein multiple broadcast signal units can be combined to enable the provision of the same information as a legacy broadcast signal. According to embodiments, the division of the broadcast signal into a plurality of broadcast signal units wherein the broadcast signal units may be arranged in various different orders and may be generated using various coding or modulation techniques. It would be understood that the criteria for arrangement, coding or modulation techniques would be known to the receivers, for example the UEs, thereby enabling the receivers to decode the broadcast signal units.

In designing synchronization signals, for example PSS and SSS, it is desirable that the synchronization signal can be acquired quickly, including the completion of decoding or detection operations and time/frequency estimates. It is also desirable to perform acquisition with low resource overhead.

There are two types of system acquisitions, which are referred to as cold and warm acquisitions. In a cold acquisition, the UE is powered-ON from a powered-OFF state. This type of acquisition is done infrequently. A warm acquisition is performed after each discontinuous reception (DRX) or sleep cycle (e.g. every few seconds) or when performing idle mode handover operations to reacquire timing/frequency. Thus optimization of warm acquisition is potentially more important than optimization of cold acquisition.

It is expected that different numerologies or profiles can be used to cover the wide frequency ranges (450 MHz to 90 GHz) that will be supported by 5G. This means for example different bandwidths, modulations, data rates, and structures of the placement of various categories of signals in sub-bands.

For 5G systems, it is considered to be desirable that the broadcast control information is decodable by UEs capable of monitoring a large bandwidth (i.e. Mobile Broadband (MBB) UEs) and UEs capable of monitoring a small bandwidth (i.e. Internet of Things (IoT) UEs).

In current LTE wireless communication systems, the Primary Synchronization Signal (PSS) and Secondary Synchronization Signal (SSS) always have to be in the same location (e.g. the center 6 Physical Resource Blocks (PRBs)) but for larger system bandwidth, better performance could be obtained if the PSS/SSS is spread over the entire bandwidth. This issue can be exacerbated in 5G given that the supported bandwidth is expected to potentially be much greater (e.g. 1.4 MHz to 1 GHz).

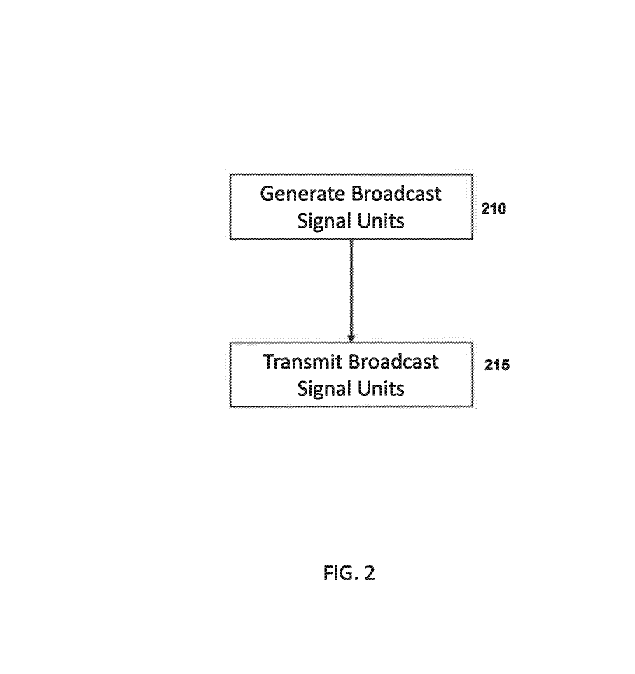

FIG. 2 illustrates a method for communicating a broadcast signal in a wireless communication network, in accordance with embodiments of the present invention. The base station, for example the eNB or other base station configuration, generates 210 one or more of broadcast signal units, wherein the generation is based at least in part of the on the broadcast signal. In some embodiments, a broadcast signal unit is configured to be a shorter broadcast sequence, such that it can be transmitted across a reduced bandwidth. In some embodiments, the reduced bandwidth is a smallest UE bandwidth (BW) that will be supported by the system. In some embodiments, the smallest UE BW is 180 kHz. The base station subsequently transmits 215 the one or more broadcast signal units in a plurality of different frequency bands.

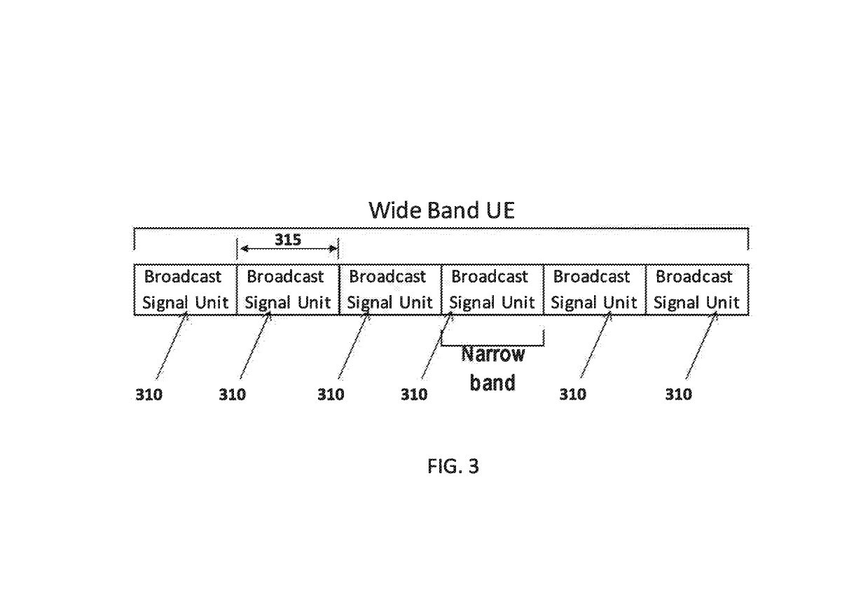

In FIGS. 3 to 6, the horizontal direction is used to convey differences in frequency. A block at a given horizontal position denotes a transmission at a given frequency.

In a first embodiment of the present invention, a shorter broadcast sequence, such as a PSS sequence, is used across the smallest UE bandwidth (BW) that will be supported by the system (e.g. a 180 kHz BW). This broadcast sequence is referred to herein as a broadcast signal unit. Higher BW UEs can concatenate multiple broadcast signal units to achieve performance comparable to that of wider band designs. To accomplish this, the broadcast signal units may be configured to span a longer time than 1 symbol (i.e. the current time spanned by a LTE PSS). FIG. 3 illustrates multiple broadcast signal units 310 each spanning a different (non-overlapping) relatively narrow frequency band of width 315, according to an embodiment of the present invention. As previously discussed, FIG. 1 illustrates a bandwidth 120 of the legacy PSS which has been presented for comparison. Instead of a single broadcast signal (e.g. PSS) spreading across the entire 1.08 MHz system bandwidth (for example, that a narrow band UE would be unable to receive), multiple broadcast signal units 310 are provided across this wide band. A narrow band UE receives one broadcast signal unit and a wideband UE receives up to all of the broadcast signal units.

In some embodiments, different broadcast signal units provide different information, or redundant information encoded in a different way. In some embodiments, different broadcast signal units provide the same information.

In some embodiments, a broadcast signal unit comprises a single PRB and a plurality of symbols, for example in some embodiments there can be a total of six symbols however this should not be considered as limiting.

In a second embodiment of the present invention, a combination of a set of static/fixed broadcast signal units and a set of dynamic broadcast signal units is employed. The static set of broadcast signal units are transmitted at known locations, for example in time and frequency, for a given 5G profile/numerology and are used for initial acquisition. The transmission schedule of the dynamic set of broadcast signal units is known only after acquisition (e.g. via information communicated in a System Information Block (SIB)) so that subsequent warm acquisitions can be performed more quickly. Higher end UEs with more capability, for example MBB UEs, may be able to blindly decode the dynamic set of broadcast signal units as well during cold acquisition, in order to improve cold acquisition. The dynamic set of broadcast signal units (e.g. the time/frequency schedule of transmissions of broadcast signal units therein) may be indicated via a SIB or may be completely dynamic (i.e. present at some times and not at other times depending on resource availability (i.e. if the system is busy or not)). In this case, a UE may be configured to use blind decoding to determine if a dynamic set is currently present.

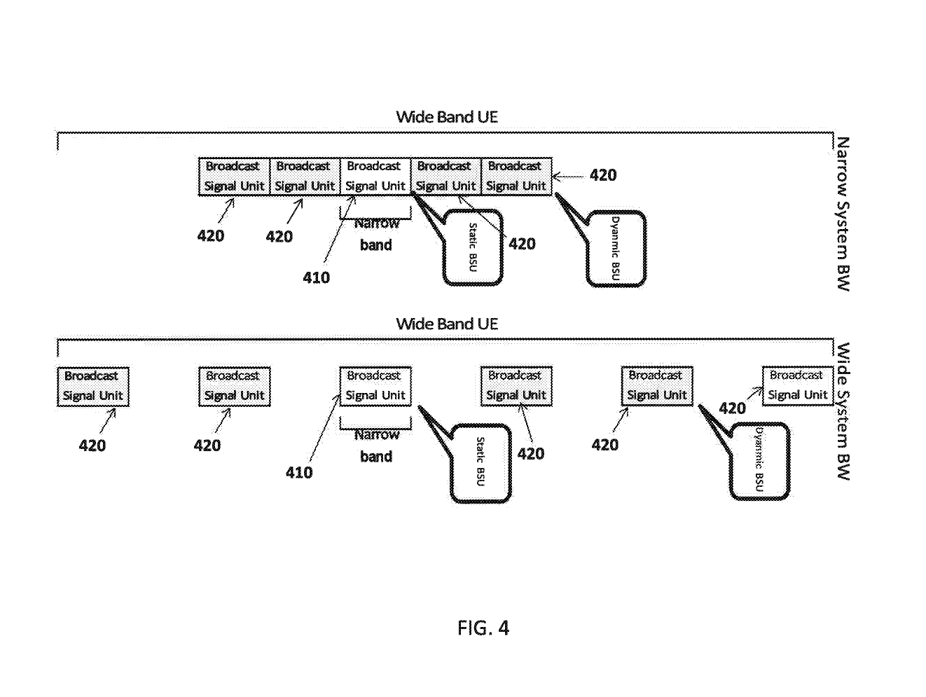

In FIG. 4, the static broadcast signal units 410 are always present at fixed and universally known times and frequencies while the dynamic broadcast signal units 420 are only available at predetermined times and frequencies that can be varied. This diagram also illustrates the third embodiment, as presented below.

In a third embodiment of the present invention, the broadcast signal units are spread out across some or all of the system bandwidth. This is illustrated in the bottom half of FIG. 4 in comparison to the top of FIG. 4 which focuses the broadcast signal units on the (contiguous) centre 6 PRBs of the system bandwidth. (The higher frequency bands, such as those of proposed 5G systems, may support 1 GHz wide channels and/or system bandwidths, for example.) Wider distribution of the broadcast signal units may improve frequency diversity performance. For example, the centre broadcast signal unit or units may be in the above-mentioned static/fixed set of broadcast signal units and the outer broadcast signal units may be in the above-mentioned dynamic set of broadcast signal units so that different BWs of systems can be supported. The dynamic set of broadcast signal units can also be used by narrow band UEs so that such UEs would not need to hop back to the static set of broadcast signal units.

In some embodiments, it is considered that the above-described static set of broadcast signal unit(s) is only decodable by narrow band UEs. In a fourth embodiment, therefore, the base station, for example an eNB, is configured to determine, based on the number and type of UEs connected, whether to boost the Power Spectral Density (PSD) of the broadcast signal unit(s) used by narrow band UEs. This decision can be made dynamically, for example on a System Frame (SF) by SF basis.

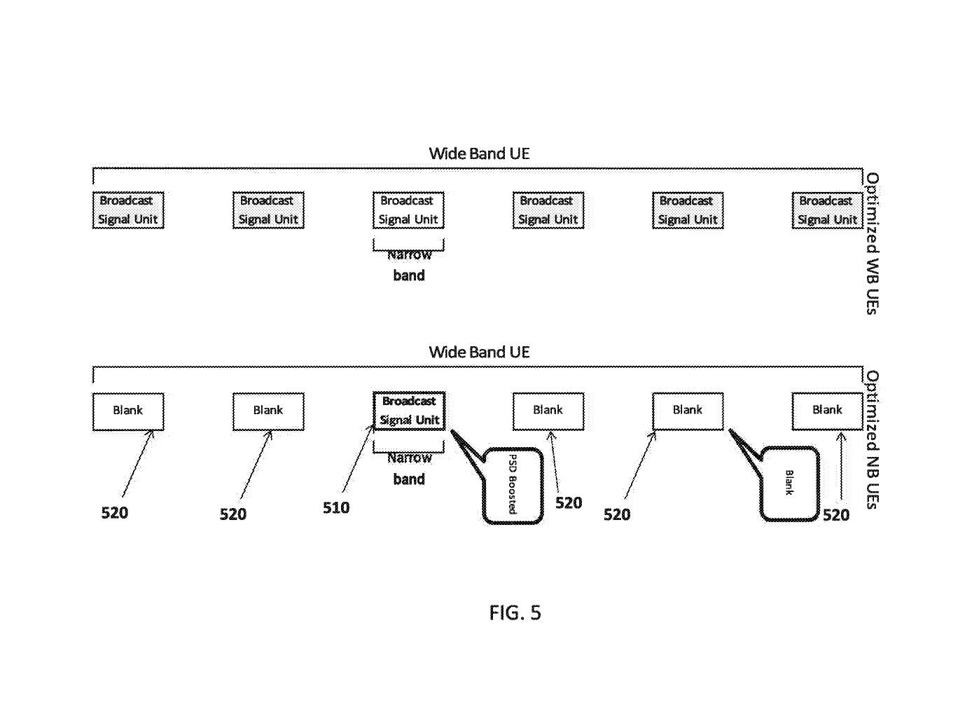

FIG. 5 illustrates controlled boosting of broadcast signal units according to an example embodiment of the present invention. The power of the broadcast signal unit may be increased while turning OFF transmission of the other broadcast signal units or other resources. In this case the overall power remains the same but is concentrated in one broadcast signal unit rather than being shared amongst all broadcast signal units. In more detail, the top part of FIG. 5 illustrates a configuration in which all six broadcast signal units are turned ON, whereas the bottom part of FIG. 5 illustrates a configuration in which five broadcast signal units 520 are turned OFF and the remaining broadcast signal unit 510 is boosted in power. The five broadcast signal units that are turned OFF may be dynamic broadcast signal units while the power-boosted broadcast signal unit may be a static broadcast signal unit.

In a fifth embodiment, in case of PSD boosting dynamic broadcast signal units, the broadcast signal units for each cell may be transmitted and/or boosted at different times. This configuration may increase the power of the broadcast signal units on one frequency on all cells simultaneously. As such, at any point in space where it is possible to receive more than one cell, all the cells will appear to have the same relative powers and will therefore interfere. In contrast, if only one cell boosts a broadcast signal unit at a given time, that broadcast signal unit will likely be received more clearly by a UE that is receiving a signal that specific cell at that time, without interference from other cells.

It is noted here that, in various embodiments of the present invention, a static broadcast signal unit cannot move and is always present.

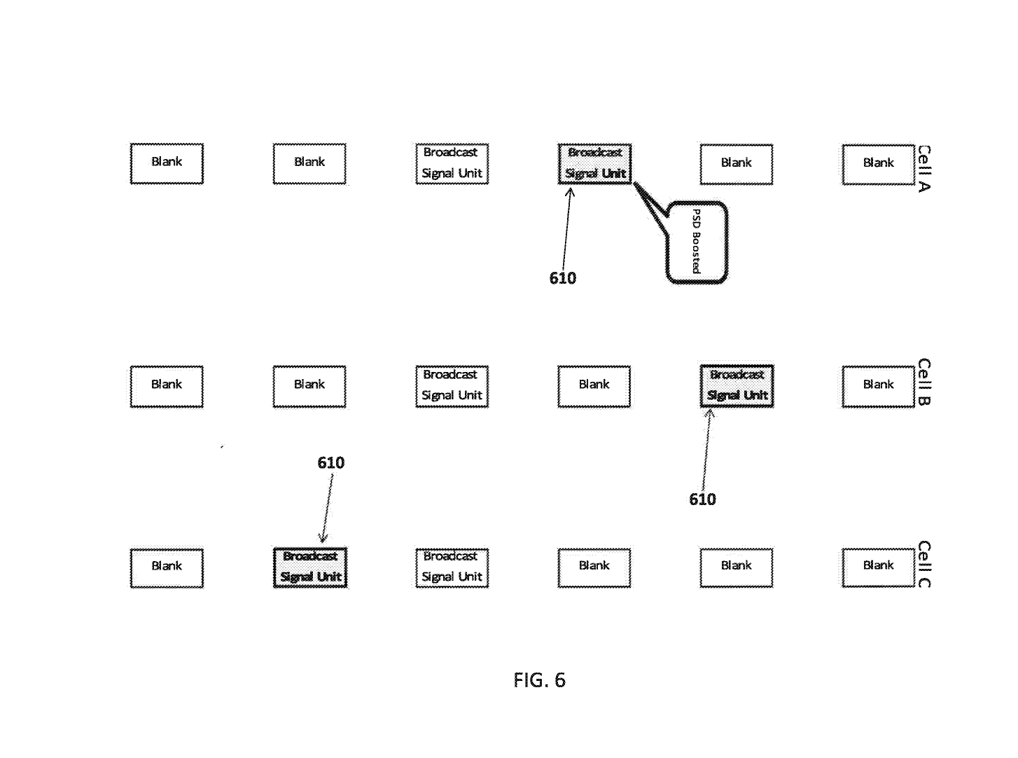

In relation to the fifth embodiment, FIG. 6 illustrates a configuration in which power-boosted dynamic broadcast signal units 610 of different cells are restricted to different frequency bands at a given time. At a later time, the positions of the power-boosted dynamic broadcast signal units may change. However, it is understood that a constraint that inhibits two cells from having power-boosted dynamic broadcast signal units which overlap in both time and frequency intervals may be upheld at substantially all times.

Embodiments of the present invention provide a wireless communication system, or one or more components thereof, which are configured to transmit and/or receive broadcast signal units in the manner described above. The components can include base stations such as eNBs, mobile devices such as machine-type wireless communication devices, mobile broadband cellular devices, narrowband mobile devices such as NB-IoT devices, or the like. Components can be configured to operate as described herein through configuration of hardware, software, firmware, or a combination thereof. The system may be described in terms of interacting modules, wherein each module corresponds to a selection of electronic components operating together to produce an effect. It should also be understood that embodiments of the present invention provide for a UE, a base station, or a system comprising same, which are configured to operate in accordance with one or a combination of the methods described herein.

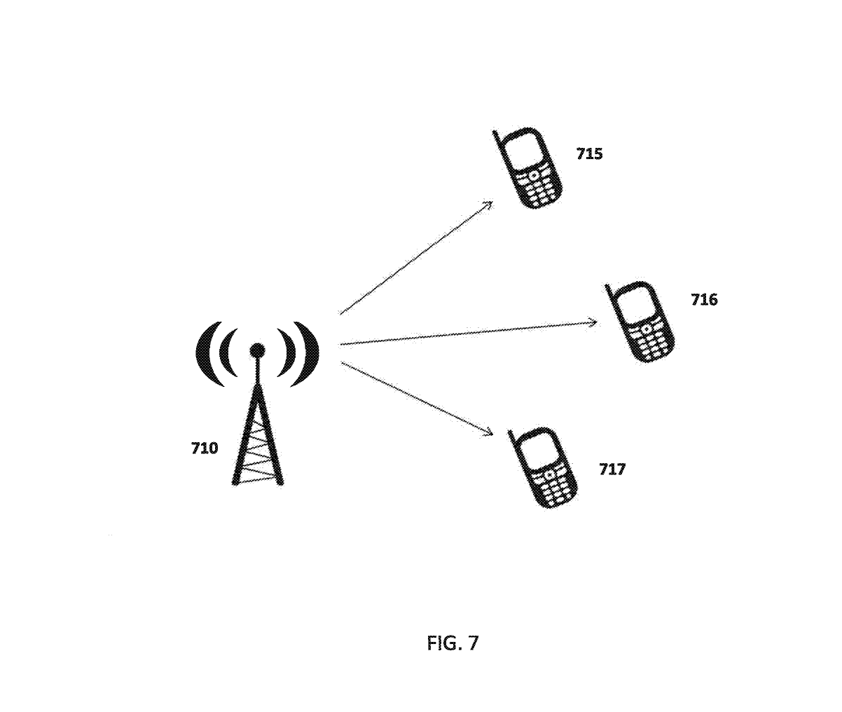

FIG. 7 illustrates a base station 710, such as an eNB, transmitting broadcast signal units to multiple wireless devices 715, 716, 717, according to an embodiment of the present invention.

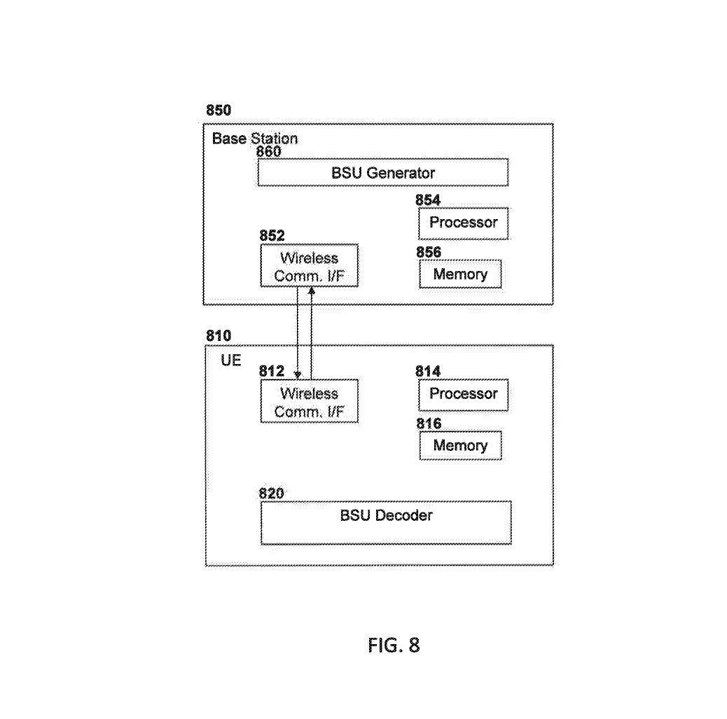

FIG. 8 illustrates a UE 810 and a base station 850, for example an eNB, of a wireless communication network, in accordance with an embodiment of the present invention. The UE 810 includes a wireless communication interface 812, a processor 814 and a memory 816. The memory 816 can include program instructions for execution by the processor 814 in order to cause the UE 810 to operate as described herein. The base station 850 includes a wireless communication interface 852, a processor 854 and a memory 856. The memory 856 can include program instructions for execution by the processor 854 in order to cause the base station 850 to operate as described herein. The UE 810 and the base station 850 communicate with each other via their respective wireless communication interfaces, for example using protocols compliant with the LTE standard.

In particular, the base station 850 is configured, for example via operation of a Broadcast Signal Unit (BSU) generator 860, to generate for transmission one or more broadcast signal units, wherein the broadcast signal units are generated at least in part based on the broadcast signal. The broadcast signals units are transmitted in a plurality of frequency bands. As would be understood the transmission of the one or more broadcast signal units can be enabled using the wireless communication interface 852.

Furthermore, the UE 810 is configured, for example via operation of a Broadcast Signal Unit (BSU) decoder 820, to decode the received one or more broadcast signal units. As would be understood reception of the one or more broadcast signal units can be enabled using the wireless communication interface 812.

As will be readily understood by a worker skilled in the art, a communication device may comprise various structural elements, such as a power source, microprocessor, memory, signal processing section, radiofrequency (RF) electronics section, antenna, and the like. In various embodiments, an existing communication device, such as a UE, M2M device, eNB, or the like, which is configured to operate in a wireless communication system such as an LTE system, may be further configured to perform various operations such as transmitting or receiving broadcast signal units, in accordance with the present invention. Such configuration may be via new software routines loaded into memory of the device and used to guide operation thereof, or similarly via new firmware routines loaded into memory for use by appropriate components such as a microcontroller or digital signal processor. Additionally or alternatively, configuration may be performed by incorporating appropriate specialized hardware, such as electronic components, microcontrollers, logic arrays, signal processing electronics, or the like, into the device. A worker skilled in the art would understand how to adjust operation of an existing communication device or to create a new communication device having the desired operating characteristics as described herein.

For example, a base station may be configured via software and/or firmware to transmit broadcast signal units by configuring wireless transmissions appropriately, for example by configuring associated physical resource blocks of wireless transmissions. The static and dynamic broadcast signal units can be transmitted accordingly, along with other information for example indicative of the schedule of dynamic broadcast signal units. A UE may be configured via software and/or firmware to receive and decode broadcast signal units, for example by acquiring potentially relevant information (e.g. indicative of static and/or dynamic broadcast signal units) from its wireless receiver and subjecting this information to decoding operations.

It will be understood that the term “base station” or “base transceiver station (BTS)” refers to an evolved NodeB (eNB), a radio access node, or another device in a wireless communication network infrastructure, such as an LTE infrastructure, which performs or directs at least some aspects of wireless communication with wireless communication devices. The term “terminal” or “UE” refers to a device, such as a mobile device, MTC device, or other device, which accesses the wireless communication network infrastructure via wireless communication with a base station.

It will be appreciated that, although specific embodiments of the technology have been described herein for purposes of illustration, various modifications may be made without departing from the spirit and scope of the technology. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for communicating a broadcast signal in a wireless communication system, the method comprising:
generating a plurality of broadcast signal units based at least in part on the broadcast signal; and
transmitting the plurality of broadcast signal units in a plurality of different frequency bands.

2. The method of claim 1, where the broadcast signal is a primary synchronization signal or a secondary synchronization signal.

3. The method of claim 1, wherein the broadcast signal is used to transmit system information.

4. The method of claim 3, wherein the system information includes System Information Blocks.

5. The method of claim 1, further comprising retransmitting at least some of the plurality of broadcast signal units at a second time.

6. The method according to claim 5, wherein each of the plurality of broadcast signal units are retransmitted in a same frequency band as previously transmitted.

7. The method according to claim 5, wherein each of the plurality of broadcast signal units are retransmitted in a different frequency band than previously transmitted.

8. The method of claim 1, wherein the frequency bands are contiguous.

9. The method of claim 1, wherein the frequency bands are spread across a system bandwidth of the wireless communication system.

10. The method of claim 1, wherein a first selected one or more of the plurality of broadcast signal units is transmitted with increased power and a second selected one or more of the plurality of broadcast signal units is omitted or transmitted with reduced power.

11. The method of claim 1, wherein when a first broadcast signal unit of a first cell and in a first frequency band is transmitted with increased power, and wherein all broadcast signal units of nearby cells to be transmitted in a frequency band overlapping the first frequency band are not transmitted or are transmitted with reduced or unboosted power.

12. A base station of a wireless communication system configured to communicate a broadcast signal, the base station comprising:
a processor; and
machine readable memory storing machine executable instructions which when executed by the processor configure the base station to:
generate a plurality of broadcast signal units based at least in part on the broadcast signal; and
transmit the plurality of broadcast signal units in a plurality of different frequency bands.

13. The base station of claim 12, where the broadcast signal is a primary synchronization signal or a secondary synchronization signal.

14. The base station of claim 12, wherein the machine executable instructions which when executed by the processor further configure the base station to retransmit at least some of the plurality of broadcast signal units at a second time.

15. The base station of claim 12, wherein each of the plurality of broadcast signal units are retransmitted in a same frequency band as previously transmitted.

16. The base station of claim 14, wherein each of the plurality of broadcast signal units are retransmitted in a different frequency band than previously transmitted.

17. The base station of claim 12, wherein the frequency bands are contiguous.

18. The base station of claim 12, wherein the frequency bands are spread across a system bandwidth of the wireless communication system.

19. The base station of claim 12, wherein a first selected one or more of the plurality of broadcast signal units is transmitted with increased power and a second selected one or more of the plurality of broadcast signal units is omitted or transmitted with reduced power.

20. A user equipment (UE) for data receipt during a period without an established communication session, the network node comprising:
a processor; and
machine readable memory storing machine executable instructions which when executed by the processor configure the network node to:
receive one or a plurality of broadcast signal units transmitted in a plurality of different frequency bands and indicative of a broadcast signal; and
decode the one or plurality of broadcast signal units.
